(19) United States
(12) Patent Application Publication
(10) Pub. No.: US 2006/0048422 A1
(43) Pub. Date: Mar. 9, 2006

(54) Promotional card carrier

(76) Inventors: Maureen Dyvig, Minnetonka, MN (US); Fredric Driver, Minneapolis, MN (US); Megan Devine, Eagan, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/935,478

(22) Filed: Sep. 7, 2004

(51) Int. Cl. G09F 3/18

(52) U.S. Cl. 40/654.01

(57) ABSTRACT

The present invention relates to a wallet-sized promotional card carrier designed to carry plastic cards such as credit, debit, gift, stored value, membership and identification cards. Embodiments of the card carrier include a pocket for holding an informational plastic card, and also provides additional pockets that may be used for receipts. Alternately, or in addition to receipt pockets, separable informational panels may be provided that can be used as coupons, advertisements, reminders, or other information. The card carrier integrates a particular informational plastic card with related information provided by the customer or the merchant into a single package that can be folded into a wallet-sized booklet shape with dimensions of about 2.5×3.5 inches.

### FIELD OF THE INVENTION

The present invention relates to wallet-sized article designed to carry informational cards such as credit and identification cards. More particularly the present invention relates to a carrier for informational cards that provides additional pockets and/or separable informational panels.

### BACKGROUND OF THE INVENTION

Various types of plastic cards have come into existence since standards for a magnetic strip were developed, such as identification, credit, membership, gift and debit cards. Use of plastic cards continues to expand with the development of smart cards such as memory cards and processor cards that carry microprocessors that enable them to store additional information or execute algorithms. Generally, these cards have been wallet-sized, as cards of this size are convenient to handle and store between uses. However, while a wallet provides a convenient means of storing and carrying financial or informational plastic cards, it does not provide a holder suitable for initial delivery of the plastic cards, or a means of associating additional items or information with the cards once they are being used.

A number of card holders capable of fitting in a wallet have been developed. One early design, patented around the time that credit cards were first being introduced, is the wallet insert described in U.S. Pat. No. 2,718,911 by Solomon. This patent discloses a wallet insert formed of transparent plastic made by folding a sheet and sealing it to form six separate compartments. Each compartment can hold two cards, and allows the cards to be viewed through the transparent plastic, and is notched at the top to allow the cards to be easily grasped and withdrawn. Card holders similar to that disclosed in the '911 patent are commonly used today, and are often integrated into the design of the wallet itself.

U.S. Pat. No. 3,537,728 by Reese discloses a combined card holder and record book. The card holder is made from a single sheet of paper that is die cut and folded to accommodate the receipt of a credit card, or a similar business or professional card, while also forming several pages within the interior of the holder that can be used to record purchases made using the card. The side of the card holder is notched to aid in the retrieval of inserted cards, and a window may be provided to view the card when it is being held within the holder.

U.S. Pat. No. 5,959,401 by Exline et al. discloses a wallet size card book adapted to hold a credit card, and fit within the credit card compartment of a wallet or similar cardholder. The wallet size card book disclosed includes a cover having a fold that divides the cover into a front cover panel and a rear cover panel; a plurality of leaves attached at the fold, the leaves forming pages. The wallet size card book includes an L-shaped glue strip extended along two edges of the inner surface of the cover; and a pocket formed by a first leaf sealed to the inner surface of the cover and cut shorter and narrower than the cover. A second leaf is sealed along two edges to the L-shaped glue strip on the cover with a third edge is secured to the fold by stitching, gluing or stapling. A fourth edge remains open for receiving a credit or information card. The use of a strong glue such as a vinyl acetate ethylene copolymer emulsion is emphasized to maintain the integrity of the card book.

U.S. Pat. No. 6,000,724 discloses an accounting book that includes a pocket for holding a credit card. The book is sized to fit within a coat pocket, wallet, or shirt pocket, and is intended to keep a log of credit card charges and credits associated with use of the card. The book has a front and back cover, with a pocket attached to the back of the front cover. The pocket is sized to carry a number of receipts, and includes a slit in which a credit card can be held. The accounting book also includes a plurality of lined pages for keeping a record of charges, inserted between the front and back covers.

None of the above mentioned patents describe the combination of structure and unique features of the promotional card carrier as described herein.

### SUMMARY OF THE INVENTION

The present invention provides a wallet-sized card carrier designed to carry plastic cards such as credit, gift, debit, store valued, membership and identification cards. In various embodiments of the present invention, the card carrier includes a pocket for holding a plastic card, and also provides one or more additional pockets that may be used for receipts. Alternately, or in addition to receipt pockets, various embodiments of the present invention may include separable informational panels that may serve as coupons. Generally, the card carriers of the present invention integrate a particular informational card, such as a plastic card, with related information provided by the customer or the merchant into a single package that can be folded into a booklet shape. In one embodiment of the present invention, the card carrier has the dimensions of about 2.5×3.5 inches.

In many of the embodiments of the present invention, the card carriers are made from a rectangular sheet of lightweight material having a top edge, two side edges, and a bottom edge. Generally, the lightweight material may be paper that has printed images. In one embodiment, the rectangular sheet includes a first fold line dividing the sheet into substantially equal first and second portions that are folded to overlap one another, forming a folded sheet; glue strips along the two side edges that seal the outside edges of the sheet when folded, forming a pocket comprising an outside surface and an inside surface; one or more secondary fold lines substantially at right angles to the first fold line spaced about 2.5 inches apart, dividing the folded sheet into a plurality of sections; and a glue strip along the inside surface of the pocket, contiguous to a secondary fold line, dividing the pocket into a card carrier section adapted for receipt of an informational card and a receipt holder section.

In particular embodiments of the informational card carrier, the card carrier section and the receipt holder section may include a notch along one edge of the open end of the pockets to facilitate retrieval of items from the pockets. The receipt holder section in such embodiments may be folded along the secondary fold lines to overlap the card carrier section, forming an informational card carrier with dimensions of about 2.5 inches by 3.5 inches. Also, various embodiments may also include one or more sheets or coatings of lightweight plastic infused or inserted between two pieces of stock paper in the manufacture of the informational card carrier to confer greater durability. The card carrier section and the receipt holder section may be printed with lines to organize recorded written information. For example, a lined wish list section may be provided to organize written information regarding desired purchases. A wish list is particularly suitable for cards delivered around the holiday season.

In addition, another embodiment of the present invention provides a promotional card carrier made from an L-shaped sheet of lightweight material, including a long rectangular back portion and a shorter rectangular foot portion. The L-shaped sheet includes a first fold line dividing the foot portion from the back portion, the foot portion being folded over to overlap one end of the pack portion; two glue strips between the overlapping foot portion and back portion, forming a pocket adapted for receipt of an informational card; and one or more perforation lines substantially at right angles to the first fold line, spaced about 2.5 inches apart, dividing the back portion of the L-shaped sheet into a plurality of detachable coupon sections.

In particular embodiments of the promotional card carrier, the pocket may include a notch along one edge of the open end of the pocket to facilitate retrieval of items from the pocket. In further embodiments, the coupon sections may be folded along the perforation lines to form a card carrier with dimensions of about 2.5 inches by 3.5 inches. The pocket may be lined and printed to organize recorded written information. Further embodiments of the invention may combine aspects of the information card carrier with the promotional card carrier; for example, a card carrier with a receipt holder and detachable coupons.

Embodiments of the present invention also describe a system for providing integrated transactional information that includes informational card and an informational card carrier as describe above, wherein the informational card carrier is printed with information or organizational lines that facilitate use of the informational card. This system is particularly useful for informational cards such as credit cards, debit cards, gift cards, identification cards and security cards.

Various embodiment of the card carriers of the present invention allow customers to carry cards, track expenses, and hold receipts associated with use of the card, while the coupons or other information provided on separable information panels may be tailored to suit the particular needs of those using a given informational plastic card. Such card carriers thus serve both the needs of those using the carrier, as well as serving a useful promotional role for merchants wishing to associate particular information such as store locations, methods of use, or coupons with a particular credit card. The card carriers are also lightweight and compact, allowing them to be easily carried within a standard wallet. The card carriers can be machine inserted into a mailing or drive-thru envelope, or offered as “take-ones”. The card carriers are relatively inexpensive to manufacture, but have sufficient durability to integrate the card and related information for a significant period of time.

### BRIEF DESCRIPTION OF THE DRAWINGS

The following figures illustrate various aspects of one embodiment of the present invention, but are not intended to limit the present invention to the embodiment shown.

FIG. 1 is a plan view of an informational card carrier including a wish list section;

FIG. 2 is a plan view of a sheet of material scored for forming an information card carrier;

FIG. 3 is a plan view of an L-shaped sheet of material scored for forming into a promotional card carrier;

FIG. 4 is top view of a folded informational card carrier;

FIG. 5 is a perspective view of a promotional card carrier.

### DETAILED DESCRIPTION

The following discussion is presented to enable a person skilled in the art to make and use the invention. Various modifications will be readily apparent to those skilled in the art, and the general principles disclosed herein may be applied to other embodiments and applications without departing from the spirit and scope of the present invention as defined by the appended claims. Thus, the present invention is not intended to be limited to the embodiments shown, but is to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of the invention. Skilled artisans will recognize the embodiments provided herein have many useful alternatives that fall within the scope of the invention.

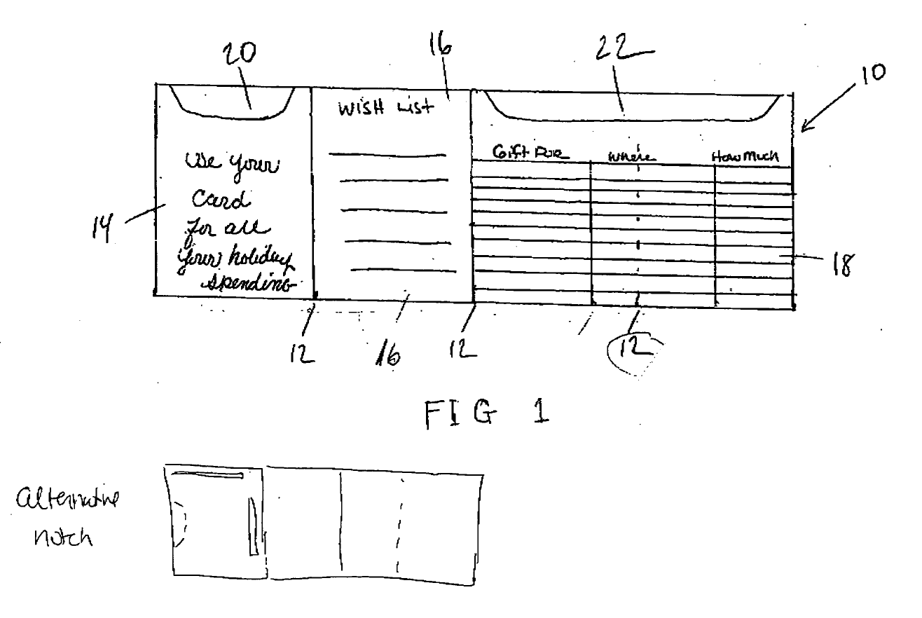

Referring to FIG. 1, one embodiment of a wallet-sized card carrier, designated 10, is shown. In particular, FIG. 1 illustrates an embodiment of the wallet-sized card carrier referred to herein as the informational card carrier. This embodiment has been designated as such as it facilitates integration of various types of information such as desired purchases, expenses charged, account balance, or transaction receipts, with the card carried in the pocket of the informational card carrier. The card carrier 10 of this embodiment is divided into several sections by fold lines 12, which are regions of the card carrier 10 that have been creased or scored in order to facilitate folding of the material at that point. Generally, the fold lines 12 are equidistant from one another and from the side edges of the card carrier 10 in order to form sections of nearly equal size that can be folded to overlap one another, preferably with slight increases in size to accommodate the overlap when folded. In a preferred configuration of the informational card carrier, each section is about 2.5 inches long. Note that while the sections have been shown in a particular arrangement in FIG. 1, the various sections may be arranged differently or may have other lengths in different embodiments of the invention. Generally, an adhesive such as a glue strip is laid down along the inside of the card carrier 10 along fold lines 12 that separate sections to form a barrier between the sections separated by the fold lines 12. However, large sections may include fold lines that are not provided with adhesive.

For the informational card carrier depicted in FIG. 1, there are three separate sections, the card carrier section 14, the wish list section 16, and the receipt holder section 18. The card carrier section 14 of this embodiment is a pocket sized to accommodate a standard, plastic credit card-sized card, which has dimensions of about 2.0 to 2.5 inches wide, preferably about 2.125 inches wide, by about 3.0 to 3.5 inches long, preferably about 3.375 inches long, and a thickness of less than about 0.125 of an inch, preferably less than about 0.063 of an inch. Embodiments of the card carrier section 14 preferably include a card cut-out notch 20 to facilitate access to the card. The card notch 20 is a portion on one side of the card carrier section 14 that has been cut away to allow an inserted card to be more readily viewed and grasped, in order to facilitate retrieval of the card. While FIG. 1 shows the card notch 20 along the upper edge of the card carrier 10, the card notch 20 may also be provided along the side edge or other positions, so long as card access is facilitated.

The information card carrier shown in FIG. 1. also includes a receipt holder section 18. The receipt holder section 18 shown actually includes two sections, resulting in a section with a width double that of the other sections. The larger size of the receipt holder section 18 is intended to more readily accommodate paper receipts that record transactions charged to the card. However, while the receipt holder section 18 may be larger than the card carrier section 14 in the embodiment shown in FIG. 1, it may be folded along a fold line 12 in its middle in order to provide a compact informational card carrier 10. It is noted that no glue is utilized along the fold line 12 that is positioned in the middle of the receipt holder section 18. While a larger receipt holder section 18 is preferred, a smaller receipt holder section 18 is within the scope of the present invention. The receipt holder section 18 is generally a pocket sized to accommodate receipts, and preferably may include a receipt notch 22. The receipt notch 22 is a portion on one side of the receipt holder section 14 that has been cut away to allow inserted receipts to be more readily viewed and grasped in order to facilitate their retrieval. As shown in FIG. 1, the receipt holder section 18 may be lined and printed in order to record information such as transactions the card was used for, or the location where particular gifts were purchased, for example. Alternately, or in addition, the receipt holder section 18 may be pre-printed with information useful in its own right, such as store locations.

Various embodiments of the card carrier 10 may also include additional sections such as a wish list section 16, for example. The wish list section 16 is an example of a section that is not intended to hold items, and is not provided with a notch portion to aid in retrieval of items. The top of the wish list section 16 may be sealed, for example by use of adhesive, since there does not need to be an access point for placement of items within the section. The wish list section 16 or other similar sections serve as additional points for recording information to be associated with use of the carried card, and should therefore generally be lined and/or printed to facilitate organizing written information recorded in this section. Information or offers can also be pre-printed in this section. Additional sections may also be provided with notches, if desired, and additional sections may provide printed information that is useful in and of itself rather than serving to organize information written down by the card user.

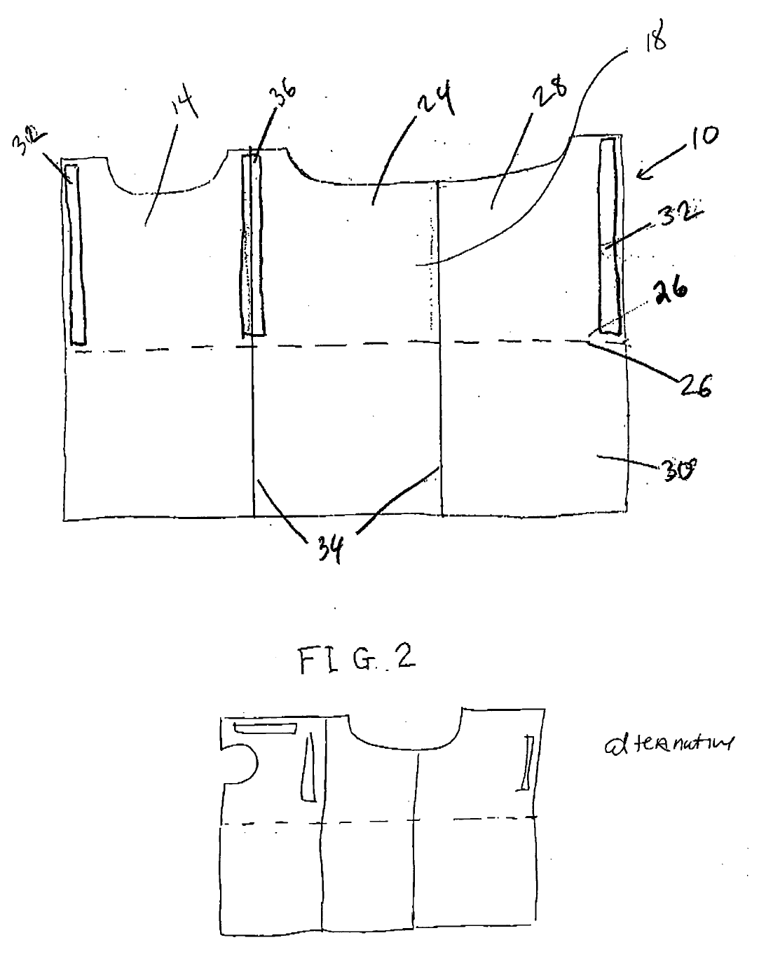

FIG. 2 provides a plan view of a sheet of material scored for forming one embodiment of an information card carrier. As shown in the figure, the card carrier 10 of this embodiment is formed from a rectangular sheet 24 of lightweight material having a top edge, two side edges, and a bottom edge. A first fold line 26 is formed that divides the sheet into substantially equal first portions 28 and second portions 30. When manufacturing the card carrier 10, these two portions are folded to overlap one another, forming a folded sheet. Glue strips 32 are deposited along the two side edges that seal the outside edges of the sheet when folded, forming a pocket comprising an outside surface and an inside surface. The glue strips 32 are placed along the inside surface, and may run the entire length of the side edge, or may only run along the edge in either the top or bottom portion, as shown in FIG. 2. One or more secondary fold lines 34 are provided, substantially at right angles to the first fold line 26, preferably spaced about 2.5 inches apart, dividing the folded sheet into a plurality of sections. An interior glue strip 36 is deposited contiguous to a secondary fold line along the side of the rectangular sheet 24 that forms the interior of the pocket once the rectangular sheet 24 has been folded. The interior glue strip 36 serves to divide one section from another; in FIG. 2, it divides the card carrier section 14 from the receipt holder section 18. The top edge of the rectangular sheet 24 (or in the alternative, the bottom edge, not shown) may include cut-out or notched portions that eventually provide access points to the pockets formed when the rectangular sheet 24 is folded along the first fold line 26.

While FIG. 2 shows notch regions with a generally arcuate shape, various other shapes and positionings can be used, so long as a portion is cut away to reveal material held within the pocket. The notch regions generally extend into the portion of the rectangular sheet 24 by about 0.375 to about 0.5 an inch. As noted for FIG. 1, the notch regions need not be located along the upper edge, and may be placed, for example, on the side edge as well. Glue strips 32 and 36 would be repositioned appropriately based on alternate locations for the notch regions. While glue strips are utilized to secure material together in the embodiment shown in FIG. 2, other means of attachment such as stitching or stapling can be utilized to adhere portions of the rectangular sheet 24 together when forming separate sections or securing the edges of the card carrier 10.

For various embodiments of the present invention, preparation of card carriers 10 may be generally accomplished by means of the following steps. First, the images, information, and/or lines are printed by using, for example, an offset printing press. In some embodiments, four-color process ink may be used on one side with an optional protective coating, such as an aqueous coating. However, it is noted that other inks may be utilized to provide the printed subject matter. The printed flat sheets are then scored and die cut (and perforated for coupons if appropriate) to form sections and the first fold line 26. The sheets are trimmed to size, using for example a guillotine cutter, and become separate flat units. These individual flat units are sent through a folder and glue strips 32 and 36 are applied to the edges to create the desired sections. Once the glue is applied, the pieces are folded horizontally in half. A cold cure glue is preferred. Folded sheets then go through a second folding unit to have the edges trimmed beyond the glue line, with additional scores applied, if needed, for final folding. As a final step, the card carrier 10 pieces go through a crusher to secure the glue and then are stacked for packing. The pieces can be folded down to final size (about 2.5×3.5 inches) at this point. Alternately, the pieces can be shipped or mailed flat.

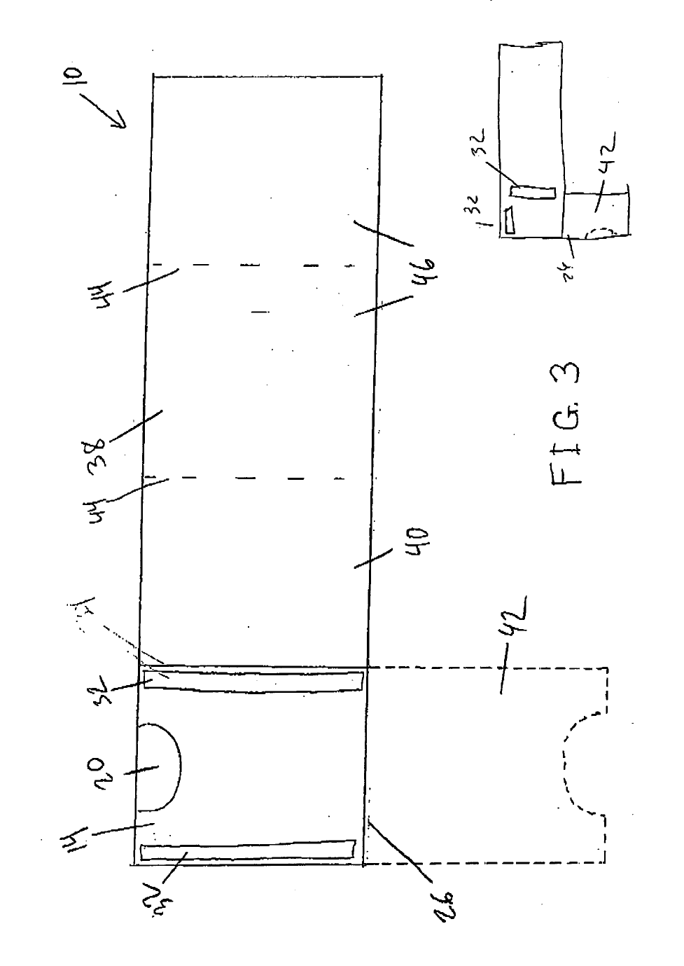

Referring to FIG. 3, a plan view of an L-shaped sheet 38 of material scored for forming into another embodiment of a wallet-sized card carrier 10 is shown. In particular, FIG. 3 illustrates an embodiment of the wallet-sized card carrier 10 referred to herein as the promotional card carrier. This embodiment has been designated as such as it facilitates integration of various types of promotional material such as coupons, tickets, and advertisements with the card carried in the pocket of the promotional card carrier.

As shown in FIG. 3, the promotional card carrier 10 may be formed from an L-shaped sheet 38 of lightweight material, comprising a long rectangular back portion 40 and a shorter rectangular foot portion 42. The sheet 38 used in this embodiment includes a first fold line 26 dividing the foot portion 42 from the back portion 40. During assembly of the promotional card carrier 10, the foot portion 42 is folded over to overlap one end of the back portion 40. Two glue strips 32 between the overlapping foot portion 42 and back portion 40 adhere these portions together, forming a pocket adapted for receipt of an informational card, designated the card carrier section 14. The L-shaped sheet 38 may also include one or more perforation lines 44 substantially at right angles to the first fold line 26, spaced about 2.5 inches apart, dividing the back portion of the L-shaped sheet 38 into a plurality of detachable coupon sections 46 or panels. The outer edge of the foot portion 42 may include a notch portion that eventually provides an access point to the card carrier section 14 formed when the foot portion 42 is folded along the first fold line 26. The notch portion generally will have dimensions within the parameters of those described for the informational card carrier, above.

The card carrier section 14 of the promotional card carrier 10 may be lined and printed to organize recorded written information. Alternately, or in addition, both the card carrier section 14 and the detachable coupon sections 46 may be printed with other types of information such as advertisements, various brief informational statements, or text and symbols designating the coupon sections as tickets or coupons. Note that while the informational card carrier shown in FIGS. 1 and 2, and the promotional card carrier shown in FIG. 3 have been described as distinct embodiments of the present invention, hybrid versions combining aspects of both embodiments are within the scope of the present invention. For example, a card carrier 10 with a receipt holder section 18 as well as detachable coupon sections 46 can be prepared. To prepare such a card carrier, a rectangular strip of material divided by perforated lines would be appended to the rectangular sheet 24 used to prepare the information card carrier 10.

To manufacture a card carrier 10 of the embodiments shown in the figures, or other various embodiments of the present invention, a flat piece of stock is cut to have the desired outline. The sheet of stock may be any material which is lightweight, easily cut, and can retain a fold and receive ink printing and marking by pen or pencil. Most types of paper will serve, as well as some plastics and coated plastics. For the informational card carrier 10 embodiment, a preferred sheet is paper consisting of two pieces of uncoated stock with plastic infused or inserted between the two. This provides a more durable card carrier, but adjustments may have to be made to accommodate tearing the material along perforation lines. Whatever printing is desired is applied to the sheet before the stock is cut. One method of cutting the stock is generally by die cutting. After the stock has been cut, crease, score, fold, or perforation lines may be added, and cold cure adhesive is applied to form the glue strips 32, and the stock is then folded over the primary fold line 26. It is noted that means to adhere the folded regions other than cold cure adhesive are contemplated within the scope of the present invention. The card carrier 10 is ready for delivery at this point, and is typically folded by the customer. However, card carriers 10 may be pre-folded to the final size prior to delivery.

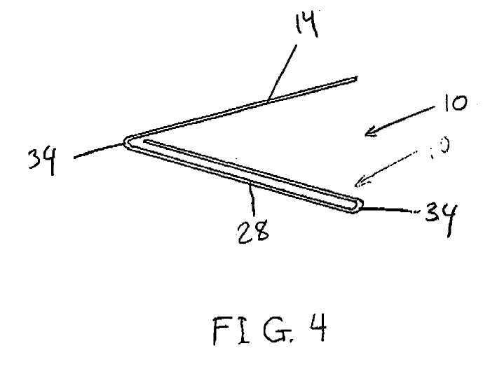

FIG. 4 provides a top view of another embodiment of a folded card carrier 10. Specifically, the embodiment shown will be described based on a folded informational card carrier 10. The receipt holder section 28 is folded in over itself, over a secondary fold line 34. The folded receipt holder section 28 is then itself folded, again at a secondary fold line 34, over onto the card carrier section 14. For sake of clarity, the informational card carrier 10 is shown partially, rather than completely, folded. In order to be readily carried within a wallet, the informational card carrier 10 occupies a relatively small amount of space when folded. Preferably, the folded card carrier 10 has length and width of about 2.5 inches by 3.5 inches, and a thickness of about ⅛th inch or less.

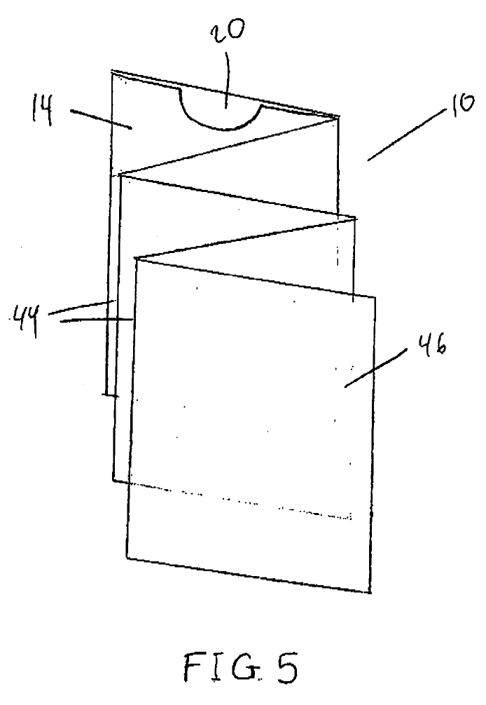

While in FIG. 4 the card carrier 10 is shown folded in one fashion, the card carrier 10 may be folded along the secondary fold lines 34 or perforation lines 44 in different directions, such as the “accordion” pattern of folding shown in FIG. 5. FIG. 5 provides a perspective view of a promotional card carrier 10, showing this type of folding pattern, in which each fold is done in a direction opposite to that done for the previous fold. The figure shows the card carrier 14 at the back of the figure, including a card notch 20, and four detachable coupon sections 46.

There are many possible uses for the card carrier 10, thus only a few will be described by way of example. One example of use of the card carrier 10 of the present invention is that it is a very good source of maintaining relevant card information, such as transactions, with the card. For example, the receipt holder section 18 allows the card holder to keep the relevant receipts associated with the card in a pocket thereby avoiding misplacement of the receipts. As noted earlier, another of the primary uses for the card carrier 10 of the present invention is to associate a particular card with information pertinent to the card. This can be useful both for merchants and consumers. For example, a business may provide a credit card along with an informational card carrier that is printed to contain information regarding credit limits, bank locations, reward systems, monthly billing times, or to organize information relating to available credit and transactions run through the card. The information may also be tailored for particular times of year—such as a card intended for holiday purchases—or for a card useful only within a specific chain, such as a card used at coffee shops. Alternately, or in addition, the card may be provided with coupons related to the particular card. For example, a card specific for use within a coffee chain might provide coupons for coffee beans, various particular drinks, or other items that the merchant is intending to promote, that a user of the card would be likely to encounter.

While various embodiments in accordance with the present invention have been shown and described, it is understood the invention is not limited thereto, and is susceptible to numerous changes and modifications as known to those skilled in the art. Therefore, this invention is not limited to the details shown and described herein, and includes all such changes and modifications as encompassed by the scope of the appended claims.

What is claimed is:

1. An informational card carrier, comprising:
(a) a rectangular sheet of lightweight material having a top edge, two side edges, and a bottom edge;
(b) a first fold line dividing the sheet into substantially equal first and second portions that are folded to overlap one another, forming a folded sheet;
(c) adhesion strips along the two side edges that seal the outside edges of the sheet when folded, forming a pocket comprising an outside surface and an inside surface;
(d) one or more secondary fold lines substantially at right angles to the first fold line dividing the folded sheet into a plurality of sections; and
(e) an adhesion strip along the inside surface of the pocket, contiguous to a secondary fold line, dividing the pocket into a card carrier section adapted for receipt of an informational card and a receipt holder section.

2. The informational card carrier of claim 1, wherein the card carrier section and the receipt holder section include a notch along one edge of the open end of the pocket.

3. The informational card carrier of claim 2, wherein the receipt holder section may be folded along the secondary fold lines to overlap the card carrier section, forming an informational card carrier with dimensions of about 2.5 inches by 3.5 inches.

4. The informational card carrier of claim 1, wherein the sheet of lightweight material comprises a plastic between two pieces of paper.

5. The informational card carrier of claim 3, wherein the card carrier section and the receipt holder section are lined and printed to organize recorded written information.

6. The informational card carrier of claim 5, further comprising a wish list section that is lined and printed to organize written information regarding desired purchases.

7. The informational card carrier of claim 1, wherein the one or more secondary fold lines are spaced about 2.5 inches apart.

8. A promotional card carrier, comprising
(a) an L-shaped sheet of lightweight material, comprising a long rectangular back portion and a shorter rectangular foot portion;
(b) a first fold line dividing the foot portion from the back portion, the foot portion being folded over to overlap one end of the pack portion;
(c) two adhesion strips between the overlapping foot portion and back portion, forming a card carrier section adapted for receipt of an informational card; and
(d) one or more perforation lines substantially at right angles to the first fold line dividing the back portion of the L-shaped sheet into a plurality of detachable coupon sections.

9. The promotional card carrier of claim 8, wherein the pocket includes a notch along one edge of the open end of the card carrier section.

10. The promotional card carrier of claim 9, wherein the coupon sections may be folded along the perforation lines to form a card carrier with dimensions of about 2.5 inches by 3.5 inches.

11. The promotional card carrier of claim 9, wherein the card carrier section is lined and printed to organize recorded written information.

12. The promotional card carrier of claim 8, wherein the one or more perforation lines are spaced about 2.5 inches apart.

13. A system for providing integrated transactional information, comprising:
(a) an informational card; and
(b) the informational card carrier of claim 1;
wherein the informational card carrier is printed with information or organizational lines that facilitate use of the informational card.

14. The system of claim 13, wherein the information card is selected from the group consisting of credit cards, debit cards, gift cards, identification cards and security cards.

15. A method of making a informational card carrier, comprising:
(a) selecting a sheet of lightweight material having a top edge, two side edges, and a bottom edge;
(b) applying a first fold line dividing the sheet into substantially equal first and second portions that are folded to overlap one another, forming a folded sheet;
(c) adhering the two side edges that seal the outside edges of the sheet when folded, forming a pocket comprising an outside surface and an inside surface;
(d) applying one or more secondary fold lines substantially at right angles to the first fold line thereby dividing the folded sheet into a plurality of sections; and
(e) applying an adhesion strip along the inside surface of the pocket, contiguous to a secondary fold line, dividing the pocket into a card carrier section adapted for receipt of an informational card and a receipt holder section.

16. The method of making an informational card carrier of claim 15, wherein the card carrier section and the receipt holder section include cutting a notch along one edge of the open end of the pocket.

17. The method of making an informational card carrier of claim 16, wherein the receipt holder section may be folded along the secondary fold lines to overlap the card carrier section, forming an informational card carrier with dimensions of about 2.5 inches by 3.5 inches.

18. The method of making an informational card carrier of claim 15, wherein selecting the sheet of lightweight material comprises selecting a plastic between two pieces of paper.

19. The method of making an informational card carrier of claim 18, wherein the card carrier section and the receipt holder section are lined and printed to organize recorded written information.

21. The method of making an informational card carrier of claim 14, further comprising a wish list section that is lined and printed to organize written information regarding desired purchases.

22. A method of making a promotional card carrier, comprising
(a) selecting an L-shaped sheet of lightweight material, comprising a long back portion and a shorter foot portion;
(b) applying a first fold line dividing the foot portion from the back portion, the foot portion being folded over to overlap one end of the pack portion;
(c) adhering the overlapping foot portion and back portion to form a card carrier section adapted for receipt of an informational card; and
(d) applying one or more perforation lines substantially at right angles to the first fold line thereby dividing the back portion of the L-shaped sheet into a plurality of detachable coupon sections.

23. The method of making a promotional card carrier of claim 22, wherein making the pocket includes cutting a notch along one edge of the open end of the card carrier section.

24. The method of making a promotional card carrier of claim 22, wherein folding the coupon sections may be along the perforation lines to form a card carrier with dimensions of about 2.5 inches by 3.5 inches.

25. The method of making a promotional card carrier of claim 22, wherein the card carrier section is lined and printed to organize recorded written information.
